(19) United States
(12) Patent Application Publication
(10) Pub. No.: US 2008/0138690 A1
(43) Pub. Date: Jun. 12, 2008

(54) Fuel Cells Containing a Fuel Soluble in Aqueous Medium and Having a Boiling Point Higher Than 65'C

(75) Inventor: Jean-Luc Dubois, Millery (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 11/814,736

(22) PCT Filed: Feb. 8, 2006
(86) PCT No.: PCT/FR06/00283

§ 371 Date: Jul. 25, 2007

(30) Foreign Application Priority Data
Feb. 9, 2005 (FR) 0501300

(51) Int. Cl. H01M 2/02; H01M 8/22

(52) U.S. Cl. 429/34

(57) ABSTRACT

Fuel cell comprising a leaktight container (A) containing a catalytic anode (1) and a catalytic cathode (2) in contact with an electrolysable liquid medium (5), current collectors (9) connected, respectively, on the one hand to the anode and to the cathode, and on the other hand to an electrical circuit (4), characterized in that the liquid medium is an aqueous medium containing a fuel that is at least partially soluble in the aqueous medium, at the temperature of use of the cell, the said fuel having a boiling point of greater than 65° C.

### FIELD OF THE INVENTION

Fuel cells are devices for converting the energy of a chemical reaction into electricity. Unlike batteries, the fuel and the oxidant are stored outside the cell. The fuel cell can thus produce energy as long as fuel and oxidant are supplied. The fuel cell produces an electromotive force by placing them in contact with two catalytic electrodes separated by or in contact with an electrolyte, which is usually in the form of a solid polymer that also acts as a barrier to the passage of gaseous reagents. The fuel is placed in contact with the anode, where it is dissociated to form ions, generally H⁺ or OH⁻, and electrons e⁻. The electrons pass into the conductive structure of the electrode (anode) and then circulate in the external electrical circuit of the system with production of energy. The ions pass through the electrolyte to the cathode. This cathode is fed with an oxidizing agent that forms at the surface, via electrochemical reduction, types of oxides that react with the charged ions to form water. Connection of the two electrodes via the external electrical circuit produces the electrical energy.

### PRIOR ART

The majority of the studies on fuel cells have related to the use of hydrogen as fuel. However, the intricate problems associated with the storage of hydrogen have led to the search for solutions involving liquid fuels, which are possibly less efficient but more manipulable.

Thus, studies have turned towards methanol, which is one of the rare reagents with hydrogen that has oxidation characteristics that are sufficiently advantageous for it to be able to be used in fuel cells operating at low and moderate temperature.

This is how direct methanol fuel cells (DMFC) came into being, and which are a separate entity from the array of fuel cells known at the present time using hydrogen, such as PEMFC (proton exchange membrane fuel cell), MCFC (molten carbonate fuel cell) or PAFC (phosphoric acid fuel cell). It should be noted that the fuel cell known as SOFC (solid oxide fuel cell) is capable of functioning with liquid fuels.

The direct methanol fuel cell is a source of energy for many applications in which a transportable, high-autonomy energy source is required, for example for laptop computers, telephones, portable tools, etc.

These direct fuel cells work according to two modes. The acid mode is the more common, and the reaction mechanism is as follows:
at the anode: CH₃OH+H₂O→CO₂+6H⁺+6e⁻,
and at the cathode: 6e⁻+6H⁺+3/2O₂→3H₂O, i.e. the overall balance is CH₃OH+3/2O₂→CO₂+2H₂O

In the basic mode of alkaline cells, the reaction mechanism is as follows:
at the anode: CH₃OH+6OH⁻→CO₂+H₂O+6e⁻
and at the cathode: 6e⁻+3H₂O+3/2O₂—6OH⁻,
i.e. the same overall balance.

Alkaline cells of this type have advantages and disadvantages compared with acid cells. Although less efficient, they do not formally need to have methanol diluted in water and they can thus use fuels that are much more concentrated than in acid-mode cells.

However, methanol has major drawbacks for bulk use, due to its toxicity, but also on account of technological limitations with existing cells.

The term “toxic product” means a product that results via inhalation, ingestion or cutaneous penetration in small amount to the death or to acute or chronic impairment of the health of an individual.

A technical limitation that will especially be mentioned is the problem of “crossover”, in which passage of methanol directly from the anode part to the cathode part, via the membrane, is observed in the cell. This phenomenon associated with the permeability of the membrane to methanol is directly associated with the currently available membrane techniques, and appears to be difficult to limit with methanol. This entails a pronounced drop in fuel, since fuel crosses the membrane without supplying electrons to be burnt in the cathode compartment, without taking into account the dysfunctions associated with this spurious reaction. Moreover, the physical characteristics of methanol can limit the conditions of use of the cell.

Studies have thus been conducted to attempt to find substitutes for methanol and, in this respect, several European or other projects are underway, for developing a cell that functions, for example, on ethanol or dimethyl ether. Mention may be made in this respect of the article by C. Lamy and E. M. Belgsir entitled “Other direct-alcohol fuel cells” in the Handbook of Fuel Cells—Fundamentals, Technologies and Applications,—vol. 1 pages 323-334; 2003 John Wiley & Sons Ltd, which reviews the alternative solutions to methanol.

Among these studies, attention may be drawn to those of Y. Tsutsumi et al., given in Electrochemistry, 70(12) (2002) 984, who compared several potential methanol substitutes: dimethyl ether (DME), methylal (DMM for dimethoxymethane) and trimethoxymethane (TMM). They conclude their study by showing that the performance of direct DMM or TMM fuel cells is virtually equivalent to that using methanol. However, according to their study, a large amount of methanol is generated in the course of the reaction at the anode with the DMM and TMM cells. DME is not a good product from the point of view of the performance of the cell, but might in practice be the best considering the toxicity factor of the degradation products at the anode. It is also worth noting the article by Jens T. Müller et al. entitled “Electro-oxidation of Dimethyl Ether in a Polymer-Electrolyte-Membrane Fuel Cell” in the Journal of The Electrochemical Society; 147 (11) 4058-4060 (2000), which mentions the problems of “fuel crossover”.

U.S. Pat. No. 6,054,228 also mentions, along with methanol, the possibility of using DMM and TMM as an alternative solution for a direct combustion fuel.

Moreover, to overcome the problem of storage of hydrogen, cells in which the hydrogen is produced gradually as required by vapour-reforming of methanol, have also been developed. The advantages of the vapour-reforming of methanol into hydrogen are:
a low conversion temperature (about 250 to 300° C.),
a high hydrogen/carbon mole ratio (4:1),
no C—C bond (unlike hydrocarbons such as petroleum spirit, kerosene or diesel) and thus less risk of soot or of carbon,
a selective process (less formation of CO compared with hydrocarbons such as petroleum spirit, kerosene or diesel),
a high content of hydrogen in methanol (75%),
no sulfur in the fuel (unlike hydrocarbons such as petroleum spirit, kerosene or diesel). Sulfur is in fact a known catalyst poison.

However, besides the toxicity problem described previously, methanol has the drawback of having a low energy density and the vapour-reforming process is slow.

### DESCRIPTION OF THE INVENTION

The Applicant has discovered that it is possible to use novel fuels for a fuel cell, functioning on the same principle as DMFCs but not having the drawbacks of methanol. The Applicant has also discovered that certain novel fuels for a fuel cell can advantageously replace methanol as a source of hydrogen by vapour reforming in hydrogen fuel cells.

One subject of the invention is thus a fuel cell comprising a leaktight container containing an anode and a cathode in contact with an electrolysable liquid medium, current collectors connected, respectively, on the one hand to the anode and to the cathode, and on the other hand to an electrical circuit; the liquid medium is an aqueous medium containing a fuel that is at least partially soluble in the said medium, at the temperature of use of the cell, and the fuel has a boiling point of greater than 65° C.

For the purposes of the invention, the term “aqueous medium” means a medium containing water and optionally a C₁ to C₄ monoalcohol. Examples of monoalcohols that may be mentioned include methanol, ethanol, isopropanol and n-propanol, and mixtures thereof.

This fuel is in particular at least partially soluble in water, especially for its use in cells of acid DMFC type.

According to the invention, the expression “at least partially soluble in the aqueous medium at the temperature of use of the cell” means a solubility of at least 3% by volume in water or the aqueous-alcoholic medium. This solubility is in particular achieved at 20° C., where necessary by heating. The solubility in water at 20° C. is, however, not a critical problem, in so far as the use of a less soluble product may be envisaged for an application at higher temperature (for example up to 40° C. in hot countries).

Advantageously, the fuel has a flash point of greater than 11° C., especially greater than or equal to 18° C., for example greater than or equal to 55° C. According to the invention, this flash point is measured at atmospheric pressure (10⁵ Pa).

According to one embodiment of the invention, the fuel has a viscosity such that the aqueous medium is pumpable by a microfluid system.

According to another embodiment, the fuel has a density, measured at room temperature (20° C.) and atmospheric pressure, of greater than 0.80, especially greater than 0.83, for example greater than 0.86 or even greater than 0.95.

In particular, the fuel is liquid or solid at room temperature (20° C.) and at atmospheric pressure.

According to one particular embodiment of the invention, the fuel is an organic compound comprising carbon and hydrogen atoms, and at least one heteroatom chosen from nitrogen and oxygen, and combinations thereof.

According to another embodiment of the invention, the aqueous medium contains a mixture of fuels, at least one of which is the fuel as described previously.

According to one mode of the invention, the anode is made of a metallic material containing platinum. Advantageously, the anode is made of a metallic material containing platinum and at least one metal chosen from ruthenium, tin, nickel and molybdenum.

According to one particular mode of the invention, the anode is made of a mixture of platinum and ruthenium, the platinum being in a content ranging from 50% to 90% by weight.

According to one embodiment of the invention, the cell is a direct fuel cell.

According to another embodiment of the invention, the cell is an indirect fuel cell, especially a hydrogen cell.

According to the invention, the cell is an autonomous and transportable source of energy.

The cell according to the invention comprises, inter alia, an electrolytic membrane separating the anode from the cathode. According to one particular embodiment of the invention, this membrane is of polymeric nature.

According to another mode, the membrane is of mineral nature.

A subject of the invention is also the use of a cell as described above, in operating portable apparatus operating on electrical energy, in particular in a portable telephone, a laptop computer or a portable tool.

The invention is also directed towards the use of a fuel as a source of energy in a fuel cell, the fuel being in accordance with the preceding description.

### Detailed Presentation of the Invention:

According to one embodiment of the invention, the cell contains one or more fuels, of the organic compound type containing from 1 to 20 carbon atoms, chosen from ether acetals, polyether acetals, carbonates, oxalates, ureas and amides, and mixtures thereof. Advantageously, the fuel is an organic compound comprising not more than 4 carbon-carbon bonds and especially from 0 to 3 carbon-carbon bonds. C—C bonds have the drawback of being difficult to break at low temperature (working temperature).

The fuels according to the present invention in particular have the following physicochemical properties:
a high boiling point and a low vapour pressure,
a higher flash point than methanol,
a lower “crossover” than methanol,
solubility (at least partial) in water when it is a water-fuel mixture that feeds the anode,
an energy density higher than that of methanol. The term “energy density” means the number of exchangeable electrons per ml of fuel,
a low viscosity, enabling them to be pumped by a microfluid system, for example ranging from 0.3 to 4 cP, measured at 25° C.

Advantageously, the fuel according to the invention is of low toxicity.

### Polyether Acetals

According to one particular embodiment of the invention, the liquid fuel for the fuel cell has the general formula: R¹—(OCH₂)ₙ—OR^{1′}

in which R¹ and R^{1′}, which may be identical or different, represent a linear or branched alkyl radical containing from 1 to 5 carbon atoms and n is an index with a value of between 1 and 8 (limits inclusive), it being pointed out that n is greater than or equal to 2 when R¹ and R^{1′}, which are identical, are a methyl radical.

Advantageously, the fuel is a compound chosen from CH₃—(OCH₂)₂—OCH₃, CH₃—(OCH₂)₃—OCH₃, CH₃—(OCH₂)₄—OCH₃, CH₃—(OCH₂)—OC₂H₅, and mixtures thereof.

These fuels are, in particular, polyoxymethylene dialkyl ethers, which will be referred to hereinbelow by the abbreviation POM for polyoxymethylene, to which will be added one or two letters (POMXX) for identifying the alkyl radicals R¹ and R^{1′}, M for methyl, E for ethyl, P or i-P for (iso)propyl, B for butyl, Pe for pentyl and H for hexyl, and also an index corresponding to the number n of units (CH₂O) (POMXXₙ).

These products are named, for example:
POMMₙ (polyoxymethylene dimethyl ether) when the alkyl is a methyl group, CH₃—(OCH₂)ₙ—OCH₃,
POME (polyoxymethylene diethyl ether) when the alkyl is an ether group,
POMP (polyoxymethylene dipropyl ether) when the alkyl is a propyl group,
POMB (polyoxymethylene dibutyl ether) when the alkyl is a butyl group.

The compound with n oxymethylene units will be known as POMMₙ. Thus, methylal (n=1), which is not targeted by the present patent application, would be known as POMM₁, and butylal will be known as POMB₁. If a mixture of products derived from the same synthesis is used, POMM₃₋₈ will refer, for example, to a mixture containing POMMs of n=3 to 8.

These POMXXs are dissymmetric when R¹≠R^{1′}. It will be possible, for example, to have a POMME₂ that will denote a polyoxymethylene methyl ethyl ether with two (CH₂O) units, i.e. CH₃—(OCH₂)₂—OC₂H₅.

Advantageously, the fuel is an acetal or a polyacetal ether of symmetrical chemical structure.

Although it may be envisaged to use this fuel in pure form, in practice, on account of the modes of synthesis used and for economic reasons, mixtures of POMXXs differentiated especially by the number of (CH₂O) units will be used.

The advantages of POMXXs are quite probably associated with their chemical nature. The reason for this is that, by means of the mode of synthesis, it is possible to control the chain length. In general, the boiling point of POMXXs increases with the number of —(CH₂O) units and with the length of the alkyl chain. On the other hand, the solubility in water decreases with the length of the (—CH₂O—)ₙ chain and with the length of the alkyl chains. An optimization may thus be made as a function of the desired final application for the fuel cell.

As regards the reaction mechanism in the cell functioning in acidic medium, it may be summarized by the following half-cell equations for a POMMₙ, i.e. at the anode in the case of acidic cells:

CH₃—(OCH₂)ₙ—OCH₃+(n+3)H₂O→(n+2)CO₂+(4n+12)H⁺+(4n+12)e⁻

and at the cathode:

(4n+12)H⁺+(4n+12)e⁻+(n+3)O₂→(2n+6)H₂O.

POMXXs may be used at lower molar concentrations than with methanol, which makes it possible to limit the losses by evaporation and by permeation. Moreover, twice as much water is manufactured at the cathode than that which is required at the anode, which may allow the implementation of a cell fed with a pure fuel diluted by recycling the water produced at the cathode.

Compared with other methanol substitutes, POMMs have the advantage of consisting of units containing 1 carbon atom (methanol+formaldehyde). There are thus no C—C bonds that are difficult to break at low temperature. These are therefore products that are readily hydrolysable in acidic medium (the electrode and the membrane may consist of acid-functionalized polymers), and that may thus be broken down into fragments of a carbon atom (oxymethylene or methoxy), which are thus readily degraded by the catalyst present at the anode. In the series of POME, POMP or POMB, there are nevertheless C—C bonds due to the alkyl groups. However, it is in accordance with the principle of the reaction mechanisms that the molecule in POM form and not in alcohol form should make it possible, via activation of the bonds during hydrolysis, to obtain higher reactivity.

Moreover, POMXXs and more particularly POMMₙs represent an advantageous alternative in terms of storage of hydrogen in the form commonly referred to as a “liquid hydride”.

The reactions involved for the vapour-reforming of POMMₙs are:

CH₃—(OCH₂)ₙOCH₃+(n+3)H₂O→(2+n)CO₂+(6+2n)H₂, i.e. (12+4n) g of H₂ per (46+30n) g of POMMₙ.

The reactions involved for the vapour-reforming of methanol are:

CH₃OH+H₂O→CO₂+3H₂, i.e. 6 g of H₂ per 32 g of MeOH.

The amount of hydrogen equivalent that may be stored in a given volume in a cell according to the invention is thus markedly higher than in the case of a methanol cell. POMXXs may thus advantageously be used for hydrogen fuel cells.

The synthesis of POMXXs has been well known for many years.

In particular, the book by J. F. Walker, “Formaldehyde”, Robert E. Krieger Publishing Company, Huntington, N.Y., 3rd Edition, 1975, is a reference book in the field. Specifically, a description of the modes of synthesis may be found therein on pages 167 et seq., on the one hand, and 264 et seq., on the other hand. These synthetic processes are based on an acid catalysis of the reaction of an alcohol, methanol, ethanol or an aldehyde, methylal or ethylal, with formaldehyde or an equivalent compound. This type of synthesis is also illustrated in many patent documents such as U.S. Pat. No. 2,449,469 or JP 47-40772.

Other modes of synthesis based on a catalysis of Lewis acid type have also been described. Mention may be made of the UK patent 1 120 524 (Institut Khimicheskoi Fiziki), which describes the synthesis of stable polyoxymethylene diethers with ionic catalysts of Lewis acid type.

Mixed POMXXs, i.e. those corresponding to the general formula with R¹ different from R^{1′}, are obtained either via direct synthesis according to the processes indicated above, or via transacetalization of two different “symmetrical” POMXXs (R¹=R^{1′}).

Ureas and Amides:

The invention is also directed towards the amide or urea fuels of formula (2) R²—CO—N(R^{2′})R²″, in which R², R² and R^{2″} independently represent a hydrogen atom or an alkyl radical containing in particular from 1 to 8 carbon atoms, for example from 1 to 3 carbon atoms.

Examples that may be mentioned include urea, methylurea, N,N′-dimethyl-urea, N-ethylacetamide and N,N-dimethylacetamide, and a mixture thereof.

### Oxalates and Carbonates:

The invention is also directed towards the oxalate or carbonate fuels of formula (3) R³—(CO)ₙ—OR^{3′}, in which R³ and R^{3′} independently represent an alkyl radical in particular containing from 1 to 8 carbon atoms, for example from 1 to 3 carbon atoms, and in which n is an integer ranging from 1 to 4, for example from 1 to 2.

By way of example, mention may be made in this class of fuels, of dimethyl carbonate (DMC) and diethyl oxalate (DEO).

Writing the half-cell reaction for DMC gives, at the anode:

CH₃—OCO—OCH₃+3H₂O→3CO₂+12H⁺+12e⁻

and at the cathode:

12H⁺+12e⁻+3O₂→6H₂O

and similarly for DEO:

C₂H₅—OCO—CO—OC₂H₅+8H₂O→6CO₂+26H⁺+26e⁻

and at the cathode:

26H⁺+26e⁻+13/2O₂→13H₂O

Twice as much water is thus manufactured at the cathode than is needed at the anode. Furthermore, DMC may be used at much lower molar concentrations than methanol, which makes it possible to limit the losses by evaporation and by permeation.

The advantages of DMC and DEO are associated with their chemical nature.

These products have the advantage of being already commercially available. Furthermore, they are of much lower toxicity than methanol.

Compared with other methanol substitutes, DMC also has the advantage of consisting of units containing 1 carbon atom (methanol+O—CO—). There are thus no C—C bonds, which are difficult to break at low temperature.

In DEO, there are still C—C bonds due to the alkyl groups and to the oxalic acid. However, it is known that oxalic acid and ethanol can be oxidized in a fuel cell.

Other characteristics and advantages of the invention will emerge more clearly on reading the description that follows, which is given as a non-limiting illustration with reference to the attached figures in which:

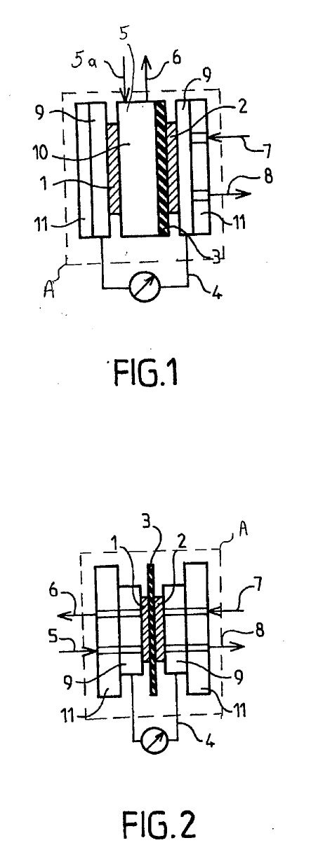

FIG. 1 is a schematic view in longitudinal cross section of a fuel cell according to the invention, according to a first embodiment;

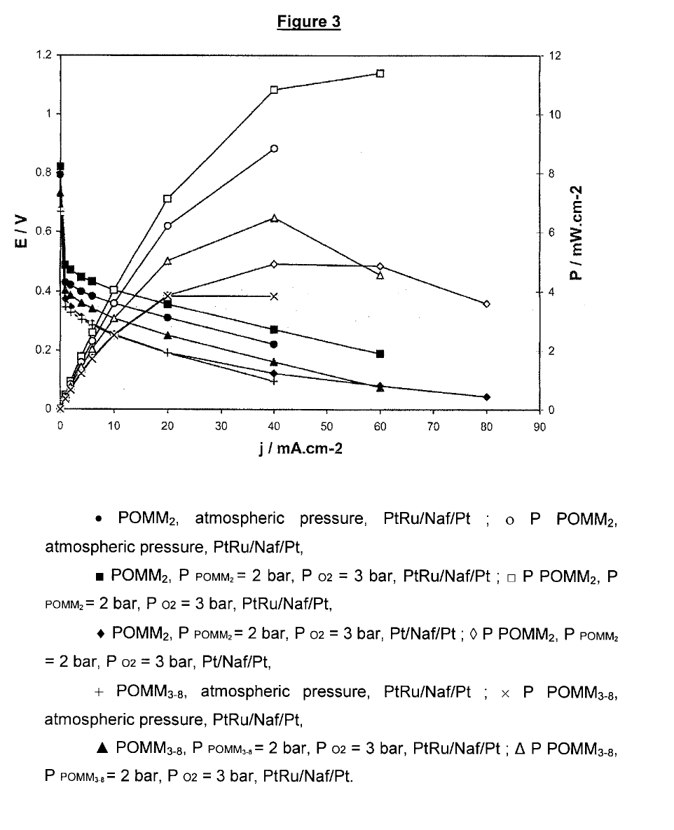

FIG. 2 is a schematic view in longitudinal cross section of a fuel cell according to the invention, according to a second embodiment;

FIGS. 3 to 12 are curves of cell voltage (E in volts) and of power (P in mW.cm²) as a function of the current density (mA.cm⁻²), under the specific implementation, fuel, electrodes, temperatures and pressure conditions.

With reference to FIG. 1, the fuel cell according to the invention comprises a leaktight container (A) containing a catalytic anode (1) and a catalytic cathode (2) in contact with an electrolysable liquid medium (5) and separated on the one hand by an electrolytic membrane (3) and on the other hand by the circulation compartment (10). Current collectors (9) are connected, respectively, to the anode (1) and to the cathode (2), on the one hand, and to an external electrical circuit (4), on the other hand, to allow the current to circulate in the circuit (4). The electrolysable medium (5) is a liquid fuel in acidic or basic aqueous medium; it is introduced via the line (5a) and the carbon dioxide produced in the cell is extracted from the circulation compartment via the line (6). Oxygen is introduced via the line (7) and the water produced is extracted via the line (8). Calenders (11) hold the assembly in position in the container (A).

The cathode is, for example, of C-Pt type. The anode is based on Pt and is, for example, either of C-PtRu type or of C-Pt type. Depending on the case, the membrane is Nafion 117 of the original cell (Nafion H TEC), a commercial Nafion 117, either one being optionally supported by a nickel grille, or, finally, a membrane of Dabco® type as described by E. Agel, J. Bouet and J. F. Fauvarque in the Journal of Power Sources, 101 (2001), 267-274.

The fuel cell of DMFC type, illustrated in FIG. 2, comprises, in each leaktight container (A):
a commercial catalytic anode (1) E-TEK, consisting either of Pt/C, 40% by mass of Pt and 2 mg.cm⁻² of Pt, or PtRu (50:50), 60% by mass of Pt and 2 mg.cm⁻² of PtRu with a 1:1 atomic ratio (geometrical area of 5 cm²),
a commercial catalytic cathode (2) E-TEK, consisting of 40% by weight of Pt/C and 2 mg.cm⁻² of platinum catalyst (geometrical area of 5 cm²),
an electrolytic membrane (3), which is a solid conductive polymer of Nafion® 117 type,
an electrical circuit (4) connected to the current collectors (9), for measuring the current characteristics (intensity, voltage),
pipes (5) for feeding the anode (1) with fuel and with water, these pipes being provided with means for measuring the flow rates and for adapting the temperature and pressure of the reagents,
pipes (6) for extracting the carbon dioxide produced at the anode,
a pipe (7) for feeding the cathode (2) with oxygen, provided with means for measuring the flow rates and for adapting the temperature and pressure, and finally
a pipe (8) for extracting the water produced at the cathode,
calenders (11) for holding the assembly in position.

### EXAMPLES

### Polyoxymethylene Dialkyl Ethers

Examples of polyoxymethylene dialkyl ethers included in the composition of the fuels according to the invention are given in Table I below with their physical characteristics. This table also includes, for comparative purposes, molecules identified by an asterisk * that are not in accordance with the invention.

TABLE I

| | Boiling | | Flash | Solubility | Molar | Dynamic |
|---|---|---|---|---|---|---|
| | point | | point | in water % | mass | viscosity |
| Molecule | ° C. | Density | ° C. | at 20° C. | g · mol⁻¹ | (cP) |
| CH₃—(OCH₂)₂—OCH₃ | 105 | 0.9597 | 14 | 31 | 106 | |
| dioxymethylene dimethyl ether | | | | | | |
| CH₃—(OCH₂)₃—OCH₃ | 156 | 1.0242 | | 28 | 136 | |
| trioxymethylene dimethyl ether | | | | | | |
| CH₃—(OCH₂)₄—OCH₃ | 202 | 1.0671 | | | 166 | |
| tetraoxymethylene dimethyl ether | | | | | | |
| C₂H₅—(OCH₂)—OC₂H₅ | 88 | 0.83 | −5 | 6.33 | 104 | 0.42 to |
| oxymethylene diethyl ether | | | | | | 25° C. |
| C₂H₅—(OCH₂)₂—OC₂H₅ | 140 | 0.91 | 33 | 4 | 134 | |
| dioxymethylene diethyl ether | | | | | | |
| C₂H₅—(OCH₂)₃—OC₂H₅ | 185 | 0.97 | | 4.5 | 164 | |
| trioxymethylene diethyl ether | | | | | | |
| i-C₃H₇—(OCH₂)—Oi-C₃H₇ | 117-119 | 0.8156 | | 1.48 | 132 | |
| oxymethylene diisopropyl ether | | | | | | |
| n-C₄H₉—(OCH₂)—On-C₄H₉ | 180 | 0.8354 | 60 | insoluble | 160 | |
| oxymethylene dibutyl ether | | | | | | |
| CH₃OH * | 65 | 0.791 | 12 | total | 32 | 0.54 to |
| Methanol | | | | | | 25° C. |
| CH₃—(OCH₂)—OCH₃ * | 42 | 0.86 | −18 | 32.3 | 76 | 0.34 to |
| methylal, DMM or | | | | | | 25° C. |
| oxymethylene dimethyl ether | | | | | | |
| CH—(OCH₃)₃ * | 114.5 | 1.1765 | | | 90 | |
| trioxymethylene methane | | | | | | |
| CH₃—(OCH₂)—O C₂H₅ | 67 | 0.83 | | | 90 | 0.42 to |
| | | | | | | 25° C. |
| 3-8 POMM mixture | 153-268 | 1.068 | 64-84 | 9.3 | 155.8 | 1.30 to |
| | | | | | | 40° C. |

### Examples 1 and 2

Two fuels according to the invention are used in Examples 1 and 2. The first is a POMM₂ with a boiling point of 105° C., a molar mass of 106 g/mol and a mass per unit volume of 0.9597 g/ml. The second is a POMM₃₋₈ with a distillation range of 153 to 268° C., a molar mass of 155.8 g/mol and a mass per unit volume of 1.064 g/ml.

These two fuels are obtained by reacting methylal with trioxane in the presence of an acidic resin, of the type such as Amberlyst® 15. The reaction medium is subjected to separation steps from which both POMM₂ and POMM₃₋₈ are obtained.

These fuels were tested in direct methanol fuel cells. Two series of tests were performed. In the first, a demonstration fuel cell of “H-TEC” type adapted for university teaching was used. The measurements of change of the voltages and current intensity and density were performed spotwise, i.e. without varying the operating conditions. The second series of tests was performed with a fuel cell of DMFC type operating in stationary regime according to the process described below.

The cell used is of H-TEC type into which was inserted a circulation compartment between the anode and the membrane according to the scheme illustrated in FIG. 1.

The experiments were all performed at room temperature, 25° C., part of them in acidic medium (Example 1) and the other part in alkaline medium Example 2 (alkaline cell). The experimental assembly used was designed to operate in alkaline medium where it is necessary to remove the carbonates synthesized during the reaction by means of the circulation compartment 1 cm thick. The size of this compartment and the medium that circulates therein considerably reduces the conductivity of the assembly and thus the current densities.

The test solutions were prepared with the same volume of fuel, i.e. for methanol or POMM₂ a 10 vol % solution of methanol or POMM₂ in water (0.1 M H₂SO₄ for the acidic medium, and 0.1 M KOH for the alkaline medium).

The measurements taken were the zero-current voltage and the zero-voltage current density.

### Example 1

The results obtained in Example 1 for the tests in acidic medium are summarized in Table 2 below.

TABLE 2

| | | | E | |
|---|---|---|---|---|
| | | | (mV) | I |
| | | | at | (mA · cm⁻²) |
| Electrodes | Membrane | Medium | I = 0 | at E = 0 |
| cathode: C—Pt | Nafion H TEC | 10% MeOH | 455 | 4.0 |
| anode: C—Pt | with Ni grille | 0.1 M H₂SO₄ | | |
| cathode: C—Pt | Nafion H TEC | 10% POMM₂ | 525 | 5.3 |
| anode: C—Pt | with Ni grille | 0.1 M H₂SO₄ | | |
| cathode: C—Pt | Nafion 117 | 10% MeOH | 595 | 2.5 |
| anode: C—Pt/Ru | with Ni grille | 0.1 M H₂SO₄ | | |
| cathode: C—Pt | Nafion H TEC | 10% POMM₂ | 760 | 3.7 |
| anode: C—Pt/Ru | with Ni grille | 0.1 M H₂SO₄ | | |

### Example 2

The results obtained in Example 2 for the tests in basic medium are summarized in Table 3 below.

TABLE 3

| | | | E | I (mA · |
|---|---|---|---|---|
| | | | (mV) | cm⁻²) |
| Electrodes | Membrane | Medium | at I = 0 | at E = 0 |
| cathode: C—Pt | Nafion 117 | 10% MeOH | 960 | 1.4 |
| anode: C—PtRu | with Ni grille | 0.1 M KOH | | |
| cathode: C—Pt | Nafion 117 | 10% POMM₂ | 967 | 2.05 |
| anode: C—PtRu | with Ni grille | 0.1 M KOH | | |
| cathode: C—Pt | CNAM-20t90-20 | 10% POMM₂ | 578 | 1.95 |
| anode: C—Pt/Ru | | 0.1 M KOH | | |
| cathode: C—Pt | CNAM-20t90-30 | 10% POMM₂ | 845 | 1.65 |
| anode: C—Pt/Ru | | 0.1 M KOH | | |
| cathode: C—Pt | CNAM-20t90-5 | 10% MeOH | 469 | 2.1 |
| anode: C—Pt/Ru | on nylon | 0.1 M KOH | | |
| cathode: C—Pt | CNAM-20t90-5 | 10% POMM₂ | 650 | 2.0 |
| anode: C—Pt/Ru | on nylon | 0.1 M KOH | | |

The object of these experiments, which was to make a first comparison between the fuels of the invention and methanol, shows that the fuel POMM₂ makes it possible to obtain, independently of the level, performance superior to that with methanol.

### Examples 3 to 10

For each fuel tested, the protocol below is applied; the cell used is in accordance with the embodiment in FIG. 2.

The cell is subjected to one hour of hydration, and then to a gradual temperature rise to 30, 50, 70, 90° C. (pressure 1 bar), which is followed by an increase in the pressure of the reagents, fuel and oxygen, which rise, respectively, to 2 and 3 bar concomitantly with the temperature that rises to 100 and then 110° C. Each step (stage) lasts about 30 minutes. The cell is then subjected to a stepwise temperature decrease, with reagents being fed at each step, either at atmospheric pressure or under pressure. The measurements (voltage, density and power) are taken during a variation, increasing or decreasing, of temperature or pressure.

The conditions of implementation of this protocol are summarized in Table 4.

TABLE 4

| | | | | | | Flow | Flow rate |
|---|---|---|---|---|---|---|---|
| | T_{cell} | T_{fuel} | T O₂ | P_{fuel} | P O₂ | rate_{fuel} | O₂ |
| Stage | (° C.) | (° C.) | (° C.) | (bar) | (bar) | ml · min⁻¹ | ml · min⁻¹ |
| 1 | 30 | 20 | 35 | 1 | 1 | 2 | 120 |
| 2 | 50 | 20 | 55 | 1 | 1 | 2 | 120 |
| 3 | 70 | 20 | 75 | 1 | 1 | 2 | 120 |
| 4 | 90 | 20 | 95 | 1 | 1 | 2 | 120 |
| 5 | 90 | 20 | 95 | 2 | 3 | 2 | 120 |
| 6 | 100 | 20 | 95 | 2 | 3 | 2 | 120 |
| 7 | 110 | 20 | 95 | 2 | 3 | 2 | 120 |
| 8 | 100 | 20 | 95 | 2 | 3 | 2 | 120 |
| 9 | 90 | 20 | 95 | 2 | 3 | 2 | 120 |
| 10 | 90 | 20 | 95 | 1 | 1 | 2 | 120 |
| 11 | 70 | 20 | 75 | 1 | 1 | 2 | 120 |
| 12 | 70 | 20 | 55 | 2 | 3 | 2 | 120 |
| 13 | 50 | 20 | 55 | 2 | 3 | 2 | 120 |
| 14 | 50 | 20 | 55 | 1 | 1 | 2 | 120 |
| 15 | 30 | 20 | 35 | 1 | 1 | 2 | 120 |
| 16 | 30 | 20 | 35 | 2 | 3 | 2 | 120 |

The cell is fed either with the mixture of reagents, fuels according to the invention or methanol each dissolved in water to a concentration of 1 mol/l for POMM₂, 1 mol/l for methanol, 2 mol/l for POMM₃₋₈, 0.5 mol/l for POM-E₁, 0.39 mol/l for POM-E₂, and 0.27 mol/l for POM-E₃. For POM-ME₁, the test solution was prepared by completing 57 ml of POM-ME₁ to 500 ml with water.

The POM-Mx fuels are obtained by reacting methylal with trioxane in the presence of an acidic resin, of the type such as Amberlyst® 15. The reaction medium is subjected to separation steps.

The fuel POM-E₁ is commercial. The other POM-Ex fuels are obtained by reacting ethylal with trioxane in the presence of an acidic resin, of the type such as Amberlyst® 15. The reaction medium is subjected to separation steps.

The fuel POM-ME₁ is obtained via a transacetalization reaction between methylal and ethylal in the presence of an acidic resin, of the type such as Amberlyst® 15. The reaction medium is subjected to separation steps.

The results obtained (measurements taken) made it possible to establish the curves of cell voltage (E in volts) and of power (P in mW.cm⁻²) as a function of the current density (mA.cm⁻²), under the specific conditions of implementation, fuel, electrodes, temperature and pressure.

### Example 3

In this example, a comparison was made between the performance of the cell functioning at 30° C. with the fuels POMM₂ and POMM₃₋₈ using different anodes, Pt or PtRu, and different pressures, either atmospheric pressure or under pressure, i.e.: O₂=3 bar and fuel=2 bar. The results obtained are illustrated by FIG. 3.

FIG. 3 shows that the fuel POMM₂ makes it possible to obtain significant performance at low temperature (below 100° C.). It appears that the pressure has a favourable effect and that the nature of the catalyst has a substantial influence; the performance with a Pt/Ru anode is superior to that obtained with a Pt anode.

### Example 4

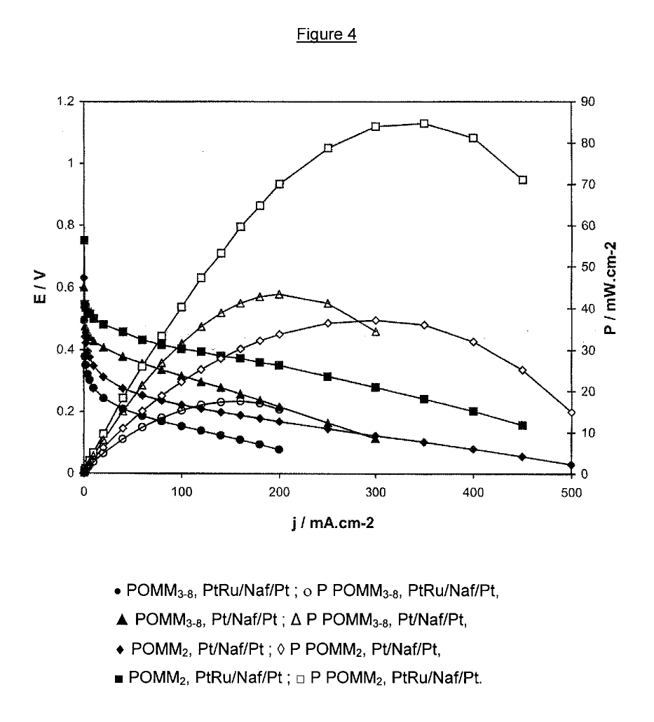

In this example, a comparison was made between the performance of the cell functioning at 90° C. with the fuels POMM₂ and POMM₃₋₈ using different anodes, Pt or PtRu, and under pressure: for O₂: 3 bar, and for the fuel: 2 bar. The results obtained are illustrated by FIG. 4.

FIG. 4 shows that the fuel POMM₂ makes it possible to obtain advantageous performance at high temperature, as does the fuel POMM₃₋₈, but to a lower degree. The favourable effect of the nature of the catalyst may be noted. The performance with a Pt/Ru anode is superior to that obtained with a Pt anode.

### Example 5

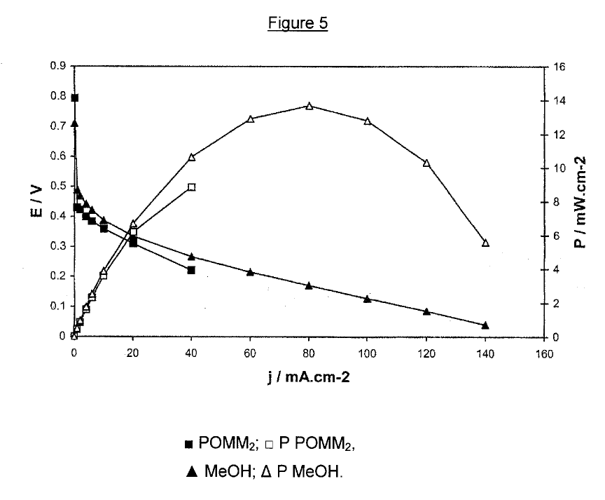

In this example, a comparison was made between the performance of the cell functioning at 30° C. with the fuels POMM₂ and methanol using the PtRu anode and atmospheric pressure. The results obtained are illustrated by FIG. 5.

FIG. 5 shows that, under these conditions, which are devoted to methanol, methanol has slightly higher performance than that of the fuel POMM₂. Also, by adapting the conditions of use of the cell to those for POMM₂, a fuel cell with good electrical properties that does not have the drawbacks of standard methanol cells will be obtained.

### Example 6

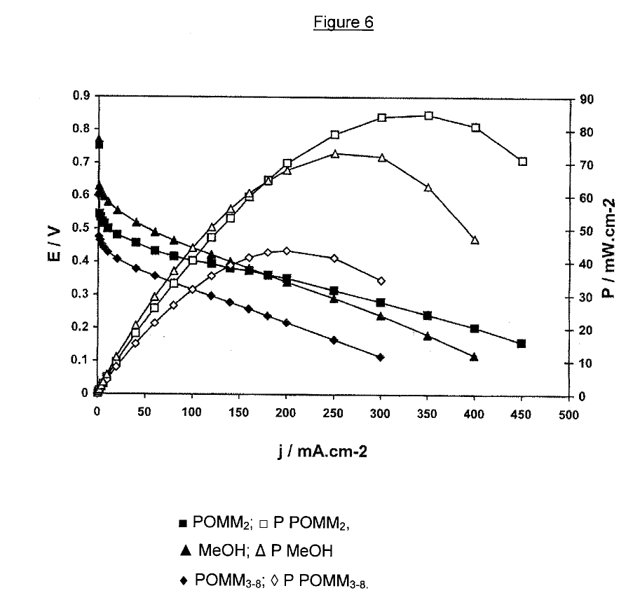

In this example, a comparison was made between the performance of the cell functioning at 90° C. with the fuels POMM₂, POMM₃₋₈ and methanol with a PtRu anode and under pressure: for O₂: 3 bar and for the fuel: 2 bar. The results obtained are illustrated by FIG. 6.

FIG. 6 shows, under these conditions, the superiority of the fuel POMM₂ compared with methanol, the fuel POMM₃₋₈ itself being of an inferior level, even though its performance remains advantageous.

### Example 7

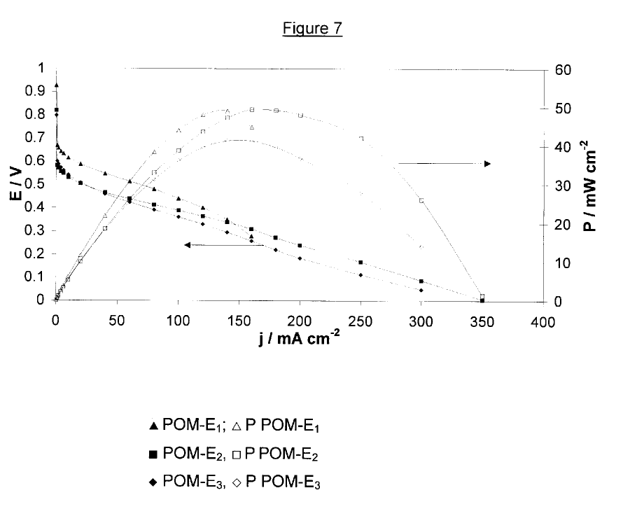

In this example, a comparison was made between the performance of the cell functioning at 110° C. with the fuels POM-E₁, POM-E₂ and POM-E₃ with a PtRu anode and under pressure: for O₂: 3 bar and for the fuel: 2 bar. The results obtained are illustrated in FIG. 7. From these curves, it is deduced that the compounds POM-E₁, POM-E₂ and POM-E₃ can function as fuel under these conditions.

### Example 8

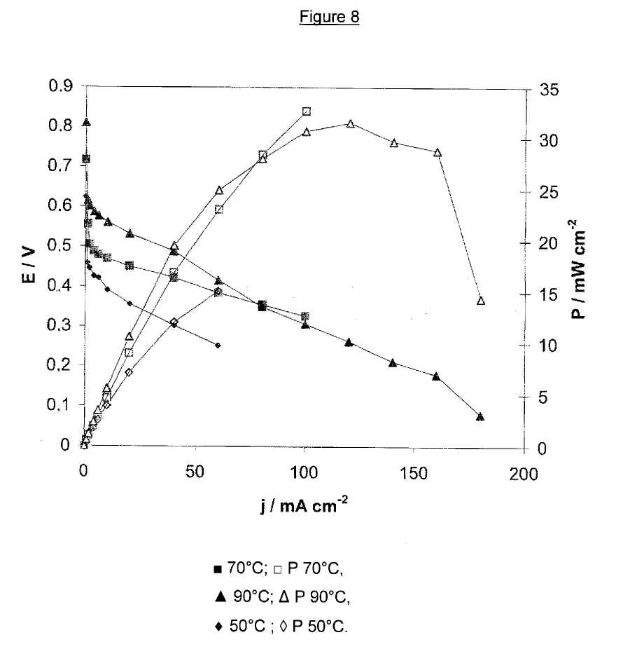

In this example, a test was made of the performance of the cell functioning with the fuel POM-ME₁ with a PtRu anode and under pressure: for O₂: 3 bar and for the fuel: 2 bar, at 50, 70 and 90° C. The results are illustrated in FIG. 8. The compound POM-ME₁ can thus function as fuel over a wide temperature range.

### Example 9

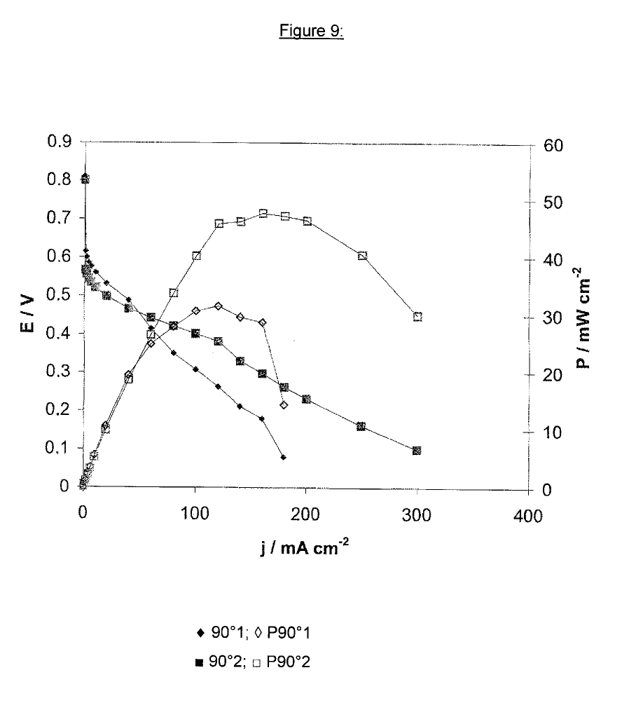

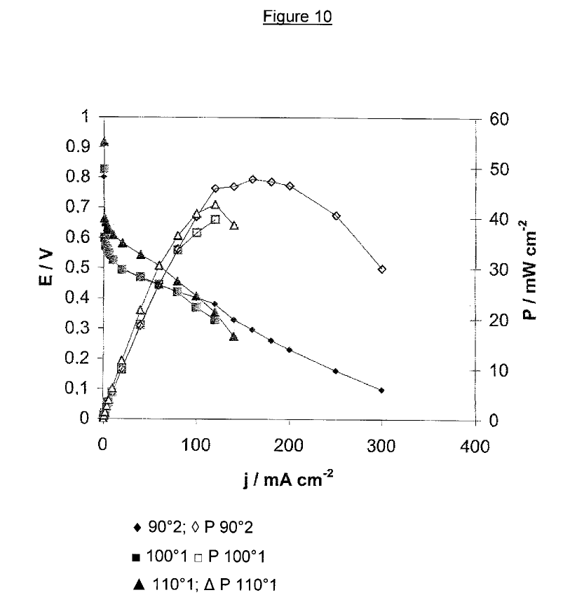

In this example, a test was made of the performance of the cell functioning with the fuel POM-ME₁ with a PtRu anode at 90° C. at atmospheric pressure (90°1) and under pressure: for O₂: 3 bar and for the fuel: 2 bar (90°2). The results are illustrated in FIG. 9. It may be observed, on reading the curves in FIG. 9, that the cell with the fuel under pressure gives better results.

### Example 10

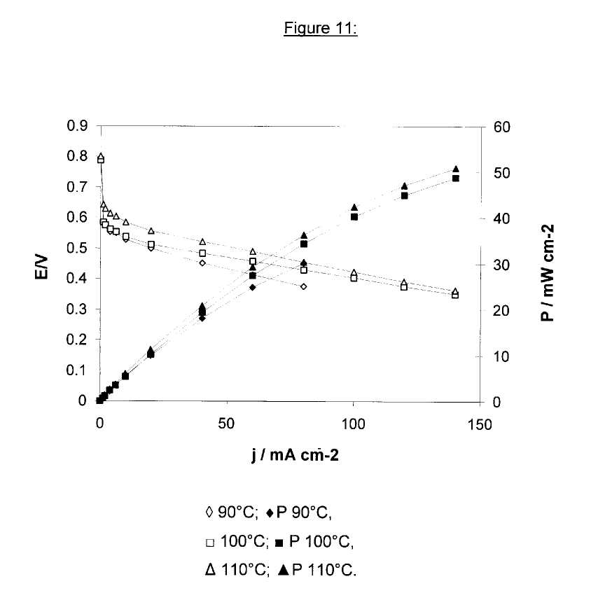

In this example, a test was made of the performance of the cell functioning with the fuel POM-ME₁ with a PtRu anode under pressure: for O₂: 3 bar and for the fuel: 2 bar, at 90, 100 and 110° C. The results are illustrated in FIG. 10. From these curves, it is deduced that the compound POM-ME₁ can function as fuel over a wide temperature range.

### Oxalates and Carbonates:

### Examples 11 and 12

Examples of oxalates and carbonates included in the composition of the fuels according to the invention are given in Table 5 below, with their physical characteristics.

TABLE 5

| | | | Flash | Solubility | Molar | Dynamic |
|---|---|---|---|---|---|---|
| | Boiling point | | point | in water % | mass | viscosity |
| Molecule | ° C. | Density | ° C. | at 20° C. | g · mol⁻¹ | (cP at 20° C.) |
| CH₃O—(CO)—OCH₃ | 90 | 1.069 | 18 | 13.9 | 90.08 | 0.625 |
| Dimethyl carbonate | | | | | | |
| (DMC) | | | | | | |
| C₂H₅O—(CO)₂—OC₂H₅ | 185 | 1.079 | 75 | 3 | 146.14 | 2.17 |
| Diethyl oxalate (DEO) | | | | | | |

The fuel cell used in these Examples 11 and 12 is in accordance with that described in Examples 3 to 10 (FIG. 2).

### Example 11

In this example, a test was made of the performance of the cell functioning with the fuel DMC with a Pt anode under pressure: for O₂: 3 bar and for the fuel: 2 bar, at 90, 100 and 110° C. The solution used has a concentration equal to 1 mol/l. The results are illustrated in FIG. 11. It is deduced from FIG. 11 that such a cell can be used at different temperatures as a source of energy.

### Example 12

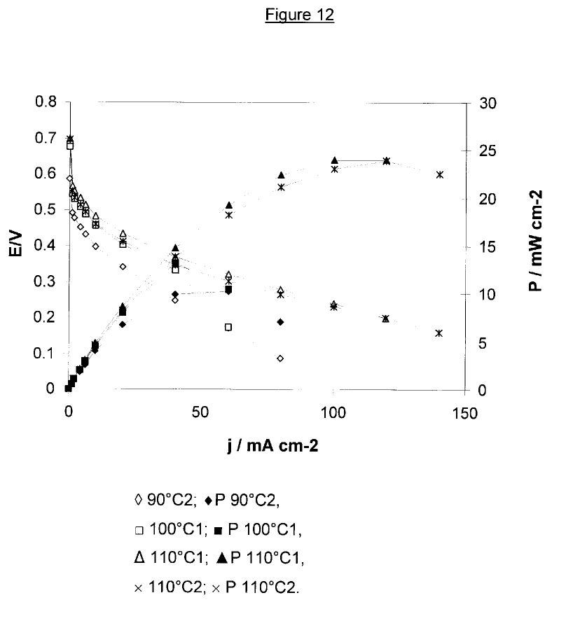

In this example, a test was made of the performance of the cell functioning with the fuel DEO with a Pt/Ru anode under pressure: for O₂: 3 bar and for the fuel: 2 bar, at 90, 100 and 110° C. The solution used has a concentration equal to 1 mol/l. The results are illustrated in FIG. 12. The curve entitled 110° C.2 represents the performance of the cell recorded 2 hours after that represented by the curve entitled 110° C.1. From these curves, it is deduced that the compound DEO can function as a fuel over a wide temperature range. Moreover, it may be seen that the performance of the cell changes very little over time, and is thus stable.

### Ureas and Amides

| | | | Flash | | Molar | Dynamic |
|---|---|---|---|---|---|---|
| | Boiling | | point | Solubility | mass | viscosity |
| Molecule | point ° C. | Density | ° C. | in water | g · mol⁻¹ | (cP at 20° C.) |
| H₂N(CO)NH₂ | | 1.335 | | 8 mol/l at | 60.06 | |
| urea | | | | 20° C. | | |
| CH₃NH(CO)NH₂ | | | | | 74.08 | |
| methylurea | | | | | | |
| CH₃NH(CO)NHCH₃ | 268-270 | 1.14 | 157 | >10 g per | 88.1 | 1.02 |
| N,N′-dimethylurea | | | | 100 ml at | | |
| | | | | 21° C. | | |
| CH₃CH₂NH(CO)CH₃ | 205-208 | 0.931 | 106.7-110 | 197 g/l | 87.13 | |
| N-ethylacetamide | | | | | | |
| (CH₃)₂N(CO)CH₃ | 163-166 | | 63-77.2 | miscible | 87.12 | |
| N,N-dimethylacetamide | | | | | | |

These urea and amide fuels can be used in a cell as represented in FIG. 1 or 2. They make it possible to obtain electrical performance comparable to that obtained in Examples 1 to 12.

1. Fuel cell comprising a leaktight container (A) containing an anode (1) and a cathode (2) in contact with an electrolysable liquid medium (5), current collectors (9) connected, respectively, on the one hand to the anode and to the cathode, and on the other hand to an electrical circuit (4), characterized in that the liquid medium is an aqueous medium containing a fuel that is at least partially soluble in the aqueous medium, at the temperature of use of the cell, the said fuel having a boiling point of greater than 65° C.

2. Cell according to claim 1, wherein the fuel has a flash point of greater than 11° C.

3. Cell according to claim 1, wherein the fuel has a flash point of greater than or equal to 18° C.

4. Cell according claim 1, wherein the fuel has a viscosity such that the aqueous medium is pumpable by a microfluid system.

5. Cell according claim 1, wherein the fuel has a density of greater than 0.8.

6. Cell according to claim 1, wherein the fuel has a density of greater than 0.86.

7. Cell according to claim 1, wherein the fuel is an organic compound comprising carbon and hydrogen atoms, and at least one heteroatom chosen from nitrogen and oxygen, and combinations thereof.

8. Cell according claim 1, wherein the fuel is an organic compound containing carbon atoms and not more than 4 carbon-carbon bonds.

9. Cell according claim 1, wherein the fuel is an organic compound chosen from ether acetals, polyether acetals, carbonates, oxalates, ureas and amides.

10. Cell according claim 1, wherein the fuel is an organic compound containing carbon atoms and from 0 to 3 carbon-carbon bonds.

11. Cell according claim 1, wherein the fuel is an organic compound containing from 1 to 20 carbon atoms.

12. Cell according claim 1, wherein the fuel is an ether acetal or polyether acetal compound of formula (1) R¹—(OCH₂)ₙ—OR^{1″} in which R¹ and R^{1′}, which may be identical or different, represent a linear or branched alkyl radical containing from 1 to 5 carbon atoms and n is an index with a value of between 1 and 8, it being pointed out that it is greater than or equal to 2 when R¹ and R^{1′}, which are identical, are a methyl radical.

13. Cell according claim 1, wherein the fuel is a compound chosen from CH₃—(OCH₂)₂—OCH₃, CH₃—(OCH₂)₃—OCH₃, CH₃—(OCH₂)₄—OCH₃, CH₃—(OCH₂)—OC₂H₅, and mixtures thereof.

14. Cell according claim 1, wherein the fuel is an ether acetal or polyether acetal of symmetrical chemical structure.

15. Cell according to claim 1, characterized in that the fuel is an amide or urea compound of general formula (2)
R²—CO—N(R^{2′})R^{2″}
in which R², R^{2′} and R^{2″} independently represent a hydrogen atom or an alkyl radical in particular containing from 1 to 8 carbon atoms.

16. Cell according to claim 15, characterized in that the amide or urea compound contains from 1 to 3 carbon atoms.

17. Cell according to claim 1, characterized in that the fuel is a compound chosen from urea, methylurea, N,N′-dimethylurea, N-ethylacetamide and N,N-dimethylacetamide, and mixtures thereof.

18. Cell according to claim 1, wherein the fuel is an oxalate or carbonate compound of general formula (3)
R³—(CO)ⁿ—OR^{3′}
in which R³ and R^{3′} independently represent an alkyl radical in particular containing from 1 to 8 carbon atoms, and in which n is an integer ranging from 1 to 4.

19. Cell according to claim 18, wherein the alkyl radical contains from 1 to 3 carbon atoms.

20. Cell according to claim 18, wherein n is an integer ranging from 1 to 2.

21. Cell according to claim 1, characterized in wherein the fuel is a compound chosen from dimethyl carbonate and diethyl oxalate.

22. Cell according claim 1, wherein the aqueous medium contains a mixture of fuels, at least one of which is the said fuel.

23. Cell according claim 1, wherein the anode (1) is made of a metallic material containing platinum.

24. Cell according claim 1, wherein the anode (1) is made of a metallic material containing platinum and at least one metal chosen from ruthenium, tin, nickel and molybdenum.

25. Cell according claim 1, wherein the anode (1) is made of a mixture of platinum and ruthenium, the platinum being in a content ranging from 50% to 90% by weight.

26. Cell according claim 1, wherein the cell is a direct fuel cell.

27. Cell according to claim 1, wherein the cell is an indirect fuel cell.

28. Cell according to claim 1, wherein the cell is a hydrogen cell.

29. Cell according claim 1, wherein the cell is an autonomous and transportable source of energy.

30. Cell according claim 1, wherein the cell comprises, inter alia, an electrolytic membrane (3) separating the anode (1) from the cathode (2).

31. Cell according claim 1, wherein the membrane (3) is of polymeric nature.

32. Cell according to one of claims 1 to 30, wherein the membrane (3) is of mineral nature.

33. Cell according to claim 1 comprising portable apparatus operating on electrical energy.

34. The cell according to claim 33, wherein the portable apparatus is a portable telephone, a laptop computer or a portable tool.

35. (canceled)
